(19) United States
(12) Patent Application Publication
(10) Pub. No.: US 2004/0223460 A1
(43) Pub. Date: Nov. 11, 2004

(54) Method and apparatus for detection of a router cable problem

(75) Inventors: Jerry W. Eldridge, Alviso, CA (US); Michael B. Shields, San Carlos, CA (US); David M. Fudenberg, Palo Alto, CA (US)

Correspondence Address: WILSON SONSINI GOODRICH & ROSATI, 650 PAGE MILL ROAD, PALO ALTO, CA, 943041050

(73) Assignee: NetGear Inc., Santa Clara, CA

(21) Appl. No.: 10/430,809

(22) Filed: May 5, 2003

(51) Int. Cl. H04L 12/26

(52) U.S. Cl. 370/242; 370/248

(57) ABSTRACT

Disclosed are a method and apparatus for automatically detecting a problem with a router cable. This can save unskilled users troubleshooting and/or installation time, and can save vendors and/or manufacturers expenses associated with end user assistance.

### BACKGROUND OF THE INVENTION

Most computer networks include a plurality of computers that are interconnected by communication paths. A network computer may access available resources outside of the local network, such as the Internet or other external network, through a router.

In a packet-switched network, a “router” is a device which receives packets on one or more input interfaces, and which outputs those packets on one of a plurality of output interfaces, so as to move those packets within the network from a source device to a destination device. Each packet includes header information, which indicates the destination device (and other information). The router includes routing information, which associates an output interface with information about the destination device (and possibly with other information). The router can also perform other operations on packets, such as rewriting the packets' headers according to their routing protocol, or to reencapsulate the packets from a first routing protocol to a second routing protocol.

A network administrator or information services (IS) specialist often configures the router to interface with a selected network and a selected Internet service provider (ISP). The process of properly configuring the router to interface with the selected network and ISP is oftentimes a complicated, time-consuming process that requires specialized knowledge on the part of administrators, let alone individual users. There are numerous device settings and network protocol settings that must be properly set, which assume a certain level of proficiency with computer networks. The number of different connection types available from ISPs today is ever increasing; one cause is the proliferation of broadband data services. A router may be connected to a typical telephone connection/plain old telephone service, and/or a high-bandwidth connection such as a cable modem, a Digital Subscriber Line (DSL) modem, or an Integrated Services Digital Network (ISDN) connection. These connection lines can require a distinct configuration for the router. Even given a particular country, e.g., USA, and a particular connection type, e.g., ADSL, each ISP may require different settings on the router. In addition, each country can have different standards and regulations governing the use of telecommunication devices, which exacerbates the lack of uniformity among the various types of connections selected by ISPs. Thus, the proper country designation may be important when configuring a router with the ISP. The globalization of the network equipment market further increases the likelihood that router configuration will only become more confusing and complicated to network administrators and end users.

A router can require proper setting of protocol configurations before it is able to establish a connection to an ISP, and external network resources such as the Internet through the ISP. It may be necessary to configure network addresses, network protocols, routing protocols, timers, and other relevant information. The protocol configuration process typically involves human intervention in setting up the interface with a selected ISP and/or local network. Even when service providers offer some assistance in the installation of a router, physical tasks must still be performed, such as connecting the right cables, positioning the router in an appropriate place within the network, and correct configuration with respect to an ISP. Each ISP may employ a specific connection type and adhere to a particular adopted protocol. Due to the ever increasing number of connection types available today, the configuration process for routers is becoming a more difficult task.

In order to minimize human intervention in configuring a router, previous solutions approached this problem from different perspectives. For example, one technique for simplifying this process involves the installation of configuration software programs or transmission of certain data from an ISP to configure the Internet settings of customer premises equipment. See U.S. Pat. No. 6,314,516 (Method and Apparatus for Configuring Communications Settings in a Computer System), which is incorporated by reference herein in its entirety. Software programs, however, must be provided in certain formats that are compatible with different operating systems that are known or identified ahead of time. Additionally, as described in U.S. Pat. No. 6,463,528 (Method and Apparatus for Simplifying the Configuration of Several Models of Customer Premise Equipment), which is incorporated by reference herein in its entirety, existing techniques may also include method and apparatus for retrieval of configuration parameters from a central system for each device to be configured. These types of systems however may be considered a limited solution from the perspective of the service provider in response to the wide variety of configurations available to customers. Similarly, in U.S. Pat. No. 6,012,088 (Automatic Configuration for Internet Access Device), which is also incorporated by reference herein in its entirety, Internet access devices can also connect automatically to the Internet to retrieve pre-assigned configuration data which is downloaded from a database stored in a configuration server established by an ISP. These proposed solutions, however, do not adequately address the challenges associated with properly configuring a router from the perspective of a user or administrator in accordance with a particular connection types and protocols established by ISPs, or the challenges associated with detecting problems encountered in setting up or using the router.

Also, many end users who encounter difficulties while configuring and/or troubleshooting a router may contact customer support for assistance from the vendor and/or manufacturer of the router. Every such contact, whether via phone, e-mail, letter, or in person, can represent an expense to the vendor and/or manufacturer. In the aggregate, such customer support expenses can reduce or eliminate the profit from the router. Thus, any automated processes which lighten the burden of customer support on the manufacturer and/or vendor can increase the profit from router sales, whether a particular request for customer support is shortened or eliminated. It can also reduce product returns, and/or increase customer satisfaction.

There is an unsatisfied need for simplifying the configuration process of Internet access devices based on particular connection types and the variety of protocols selected by various ISPs, and/or troubleshooting problems that may be encountered during the configuration and/or use of the router.

### SUMMARY OF THE INVENTION

Some embodiments of the invention provide methods and apparatuses to assist laypersons or those with limited knowledge of networks in the configuration of routers according to particular connection types used to communicate with Internet service providers (ISPs), and/or troubleshooting router problems.

In some embodiments, a problem with a cable connecting a router and an upstream communication device is automatically detected, and a graphic automatically displaying on a screen, indicating the problem with the cable.

Some embodiments use code in hardware and/or software to automatically detect a problem with a cable connecting a router and an upstream communication device, and automatically display on a screen a graphic indicating the problem with the cable.

Other goals and advantages of the invention will be better appreciated and understood when considered in conjunction with the following description and the accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. Many changes and modifications may be made within the scope of the invention without departing from the spirit thereof, and the invention includes all such modifications.

### BRIEF DESCRIPTION OF THE DRAWINGS

The advantages and features of invention are described herein with reference to the exemplary embodiments and accompanying drawings. It shall be understood that similar or like reference numerals and characters may designate the same or like parts when they occur in more than one view or figure. It should be further noted that the features illustrated in the drawings are not necessarily drawn to scale.

FIG. 1 is a simplified illustration of a router communicating with an external network.

FIG. 2 is a simplified illustration of a graphic displayed on a computer indicating a problem with a cable between a router and an upstream communication device.

FIG. 3 is a simplified illustration of a graphic displayed on a router indicating a problem with a cable between the router and an upstream communication device.

FIG. 4 is a simplified flowchart of a automatically displaying a graphic indicating a problem with a cable.

### DETAILED DESCRIPTION OF THE INVENTION

The various features and advantages of the invention are explained more fully below with reference to the illustrative embodiments shown in the accompanying drawings.

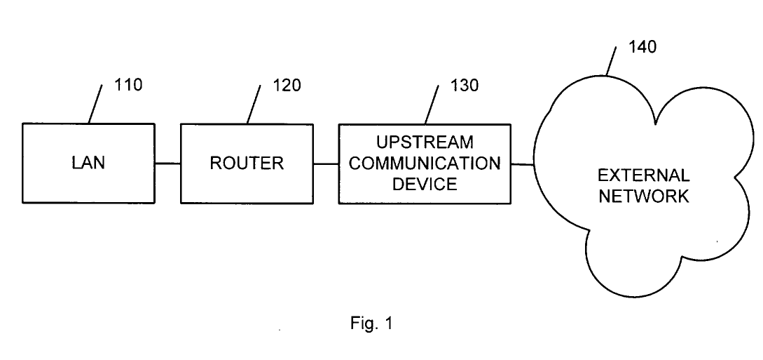

FIG. 1 illustrates a common architecture for computers communicating with external network resources such as the Internet. A local area network 110, which can include one or more computers, communicates with the external network 140. The local area network 140 sends data through router 120 and an upstream communication device 130.

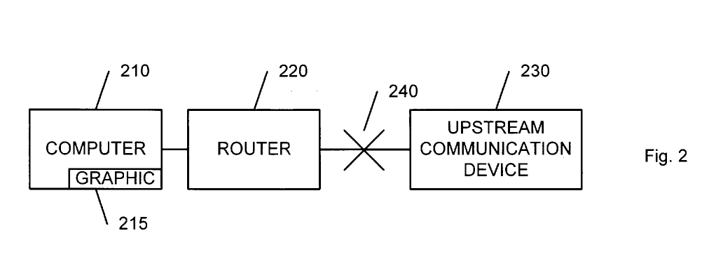

FIG. 2 illustrates an architecture for computers communicating via a router. A computer 210 attempts to communicate with an upstream communication device 230 via a router 220. A problem is detected with cable 240. This problem is indicated in a graphic 215 displayed on computer 210.

The computer can display on a screen a graphic indicating the cable problem. The screen is a user-friendly location to notify the user of a problem as compared to, for example, an indicator such as a light (e.g., an LED) on the router and/or a sound from the router. Some users may not want to monitor the router for visual and/or audio indicators that indicate a problem with the cable. Nevertheless, some embodiments not only display the screen graphic, but also display the indicator.

The graphic can communicate relatively basic information and/or relatively detailed information. Basic information can include the mere existence of the cable problem. Detailed information can include details instructing the user about the particulars of the cable problem and/or troubleshooting details instructing the user how to remedy the cable problem. The graphic indicating the problem can include textual and/or pictorial data.

By displaying this textual and/or pictorial data about the cable problem on the screen, the amount and specificity of information which can be communicated to the user is greatly increased. Unlike simple light and/or sound indicators from the router, which may be content limited due the limited surface area on the outside chassis of the router, a displayed graphic may take up anywhere from a small portion of the screen to the entire screen. Further, unlike simple light and/or sound indicators from the router, which affect the external appearance of the hardware design of the router and therefore can be quite limited in the range of different messages to be communicated, a displayed graphic can display a wide range of messages about the cable problem.

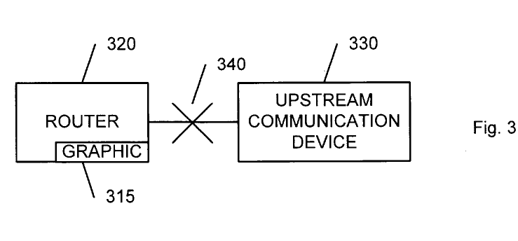

The display can be a computer monitor of a computer downstream from the router. The display can also be integral to the router, as shown in FIG. 3.

FIG. 3 illustrates an architecture for computers communicating via a router. A router 320 attempts to communicate with an upstream communication device 330. A problem is detected with cable 340. This problem is indicated in a graphic 315 displayed on router 320.

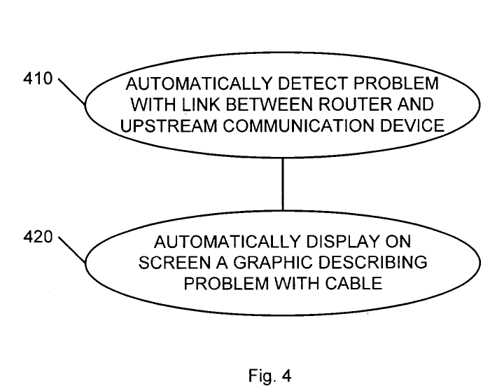

FIG. 4 illustrates a flowchart for problem detection.

In 410, a problem is automatically detected with a cable between a router and an upstream communication device. “Automatic” can indicate that a user does not have to instruct the router or computer to find a problem with the cable connecting the router and the upstream communication device. Instead, the router or computer can attempt to find a problem with the cable connecting the router and the upstream communication device without being specifically instructed to do so by the user. Thus, the user can be freed from learning the many possible reasons that can impair data communication, such as cable problems, and/or, in the event a cable problem exists, troubleshooting for various possible causes of cable problems. For both skilled and novice users, automatic detection can make it unnecessary to remember to check for a cable problem.

In 420, a graphic is automatically displayed on a screen. The graphic describes the problem with the link. “Automatic” can indicate that the user does not have to instruct the computer to indicate the problem, such as the existence of the problem and/or the type of the problem. For both skilled and novice users, automatic detection can make it unnecessary to remember to follow up an instance of a detected cable problem with a manual request to indicate the cable problem.

Some embodiments detect the cable problem by checking a link status between the router and the upstream communication device.

While the invention has been described with reference to the aforementioned specification, the descriptions and illustrations of the preferable embodiments herein are not meant to be construed in a limiting sense. It shall be understood that all aspects of the invention are not limited to the specific depictions, configurations or relative proportions set forth herein which depend upon a variety of conditions and variables. Various modifications in form and detail of the embodiments of the invention, as well as other variations of the invention, will be apparent to a person skilled in the art upon reference to the present disclosure.

What is claimed is:

1. A method for detecting a connection problem, comprising:
automatically detecting a problem with a cable connecting a router and an upstream communication device; and
automatically displaying on a screen a graphic indicating the problem with the cable.

2. A method of claim 1, wherein the graphic includes textual data.

3. A method of claim 1, wherein the graphic includes pictorial data.

4. A method of claim 1, wherein automatically detecting the problem with the cable includes checking a link status between the router and the upstream communication device.

5. A method of claim 1, wherein the problem with the cable is at least partly caused by the cable being plugged into an incorrect port of the upstream communication device.

6. A method of claim 1, wherein the problem with the cable is at least partly caused by the upstream communication device being a powered off state.

7. A method of claim 1, wherein the problem with the cable is at least partly caused by the upstream communication device being unplugged from a power outlet.

8. A method of claim 1, wherein the problem with the cable is at least partly caused by an incorrect type of the cable.

9. A method of claim 1, wherein the problem with the cable is at least partly caused by a length of the cable.

10. A method of claim 1, wherein the problem with the cable is at least partly caused by a break in the cable.

11. A method of claim 1, wherein the problem with the cable is at least partly caused by a misconnection in the cable.

12. A method of claim 1, wherein the problem with the cable is at least partly caused by incomplete attachment between the cable and the router.

13. A method of claim 1, wherein the problem with the cable is at least partly caused by incomplete attachment between the cable and the upstream communication device.

14. Computer code for detecting a connection problem, comprising:
code that performs automatically detecting a problem with a cable connecting a router and an upstream communication device; and
code that performs automatically displaying on a screen a graphic indicating the problem with the cable.

15. Apparatus for detecting a connection problem, comprising:
means for automatically detecting a problem with a cable connecting a router and an upstream communication device; and
means for automatically displaying on a screen a graphic indicating the problem with the cable.
